(19) United States
(12) Patent Application Publication
(10) Pub. No.: US 2025/0328350 A1
(43) Pub. Date: Oct. 23, 2025

(54) Branch Status Table and Control Instruction Buffer for Processor Instruction Pipeline

(71) Applicant: Tenstorrent USA, Inc., Austin, TX (US)

(72) Inventors: Ashok T Venkatachar, Fremont, CA (US); Alexander C. Rucker, Santa Clara, CA (US); Soundharya Balasubramanian, San Jose, CA (US); Yasuo Ishii, Palo Alto, CA (US)

(21) Appl. No.: 19/018,392

(22) Filed: Jan. 13, 2025

Related U.S. Application Data
(60) Provisional application No. 63/635,607, filed on Apr. 17, 2024.

(51) Int. Cl. G06F 9/38

(52) U.S. Cl. CPC G06F 9/3806; G06F 9/3867

(57) ABSTRACT

Systems and methods related to a branch status table and control instruction buffer for processor instruction pipeline are disclosed herein. A processor may include a branch status table and a control instruction buffer. The branch status table may be formed by a set of registers and may store a set of pointers that correspond with a set of branches. The control instruction buffer may store a set of instruction pipeline control data entries in a set of addresses. The pointers may identify addresses which store the most recent instruction pipeline control data entries which proceed the branches that correspond with the pointers. Beneficially, when a branch misprediction occurs, the data structure can effectively be rewound to a point just before the misprediction with minimal overhead.

### CROSS REFERENCE TO RELATED APPLICATIONS

This application claims the benefit of U.S. Provisional Patent Application No. 63/635,607, filed Apr. 17, 2024, which is incorporated by reference herein in its entirety for all purposes.

### BACKGROUND

In a computer processor, certain instructions play a pivotal role in configuring the processing pipeline, thereby influencing the execution of regular instructions. The instructions can be referred to as “control instructions” to distinguish them from regular instructions which directly define the computations that are being executed by the processing pipeline. These control instructions govern various aspects of the pipeline's behavior, such as fetching, decoding, executing, and writing back data. By adjusting parameters like the size of the operands for the instructions and the size of the instructions themselves, these control instructions optimize the pipeline's efficiency and throughput and generally expand the capabilities of the instruction set.

In the context of processors that utilize the RISC-V instructions set, an example of a control instruction is the “vset” instruction, which plays a crucial role in configuring vector processing units. This instruction allows programmers to set parameters such as vector length, data layout, and execution mode, tailoring the vector unit's behavior to suit specific computational tasks. The vset instruction writes a value to an architectural register that can be referred to as the vtype register. By adjusting the parameters in the vtype register, the vset instruction effectively shapes the execution characteristics of subsequent vector instructions, optimizing performance for tasks like parallel data processing and numerical simulations. Moreover, the vset instruction's flexibility empowers developers to adapt the vector unit's configuration dynamically, enabling efficient utilization of hardware resources and enhancing overall system performance. Thus, within the broader context of control instructions, the vset instruction exemplifies how fine-tuning the configuration of specialized processing units can significantly impact the execution of regular instructions, ultimately driving advancements in computational efficiency and performance.

### SUMMARY

Systems and methods related to control instructions in computer processors are disclosed herein. In specific embodiments of the invention, methods and systems are provided that efficiently enforce execution of instructions with respect to the appropriate control instruction. In specific embodiments of the invention, a processor includes a branch status table and a control instruction buffer. The control instruction buffer can store a set of instruction pipeline control data entries in a set of addresses. The set of instruction pipeline control data entries can be the contents of control instructions. For example, in the context of a RISC-V processor, the control data entries can be the contents of a vset instruction. The branch status table may track the information of a stream of consecutive instructions. Each entry in the branch status table may correspond to a fetch bundle of instructions. A fetch bundle of instructions may also be referred to a fetch group of instructions, a set of instructions, a block of instructions, or a bundle of instructions. The fetch bundle may be a series of instructions appearing in program order and may include multiple not-taken branches and up to one taken branch. An entry in the branch status table may not track any branch instruction, may track one branch instruction, or may track multiple branch instructions depending on the fetch bundle of instructions that the entry refers to.

If the fetch bundle has multiple not-taken branches, it is possible that a mis-predicted branch will unwind some control instructions (e.g., vtype entries) but not others. To recover from the misprediction, the control instruction buffer may track program counter offset values (relative to the beginning of the fetch bundle) for each control instruction. The mis-predicted branch may also have an offset within the fetch bundle. When recovering, the pointer in the branch status table that points to the control instruction buffer may be used to begin the search, and then the offsets may be used to identify the last control instruction before the mis-predicted branch inside the fetch bundle.

In specific embodiments, the branch status table can store information regarding a set of potential branches of the program and a set of pointers. The pointers can be in a one-to-one correspondence with the set of branches. The pointers can identify addresses in the control instruction buffer. The addresses identified by the pointers can store the oldest instruction pipeline control data entries that are associated with the branches that correspond with the pointers. Using the approaches disclosed herein, the entries in the control instruction buffer can be used to ensure that the appropriate control instruction is available for use by the instruction pipeline at any given time regardless of branch mispredictions, while at the same time minimizing the size of the branch status table as compared to alternative approaches.

In specific embodiments, the branch status table can be formed by a set of registers and can store a set of pointers in one-to-one correspondence with a set of branches. The branches from the set of branches can be branches which the instruction decode logic is predicting that the program will take in accordance with standard instruction processing pipelines that prefetch instructions before the path of the instructions is known to increase the efficiency of the pipeline. The branch status table can store data associated with a given branch in a register of the branch status table. Pointers in the set of pointers that correspond with branches can be stored in the same register with the remaining data regarding their corresponding branch.

In specific embodiments of the invention, a processor is provided. The processor comprises a branch status table formed by a set of registers and storing a set of pointers that correspond with a set of branches. The processor further comprises a control instruction buffer storing a set of instruction pipeline control data entries in a set of addresses, wherein the pointers, in the set of pointers, identify addresses, in the set of addresses, which store a set of most recent instruction pipeline control data entries, in the set of instruction pipeline control data entries, which proceed the branches, in the set of branches, that correspond with the pointers.

In specific embodiments of the invention, a method is provided. The method comprises: storing entries for a set of branches in a branch status table formed by a set of registers, storing a set of pointers in the branch status table, and storing a set of instruction pipeline control data entries in a set of addresses of a control instruction buffer, wherein the pointers, in the set of pointers, identify addresses, in the set of addresses, which store a set of most recent instruction pipeline control data entries, in the set of instruction pipeline control data entries, which proceed the branches, in the set of branches, that correspond with the pointers. The method further comprises executing, by an instruction execution pipeline, an instruction using a most recent entry to the control instruction buffer.

In specific embodiments of the invention, a processor is provided. The processor comprises a branch status table formed by a set of registers, a register of the set of registers storing a pointer and information about a set of instructions. The processor further comprises a control instruction buffer storing a set of instruction pipeline control data entries in a set of addresses, wherein the pointer identifies an addresses, in the set of addresses, which stores a set of most recent instruction pipeline control data entries, in the set of instruction pipeline control data entries, which proceeds the set of instructions.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a branch status table and a control instruction buffer in the context of an instruction map in accordance with specific embodiments of the inventions disclosed herein.

FIG. 2 provides an example of a branch status table and a control instruction buffer in the context of an instruction map with an additional decoded control instruction in accordance with specific embodiments of the inventions disclosed herein.

FIG. 3 provides an example of four fetch groups in an instruction map, where each entry in the branch status table may track information of a fetch group in accordance with specific embodiments of the inventions disclosed herein.

FIG. 4 provides an example of adding entries to a control buffer and a branch status table when fetching a fetch group of instructions in accordance with specific embodiments of the inventions disclosed herein.

FIG. 5 provides an example of a method for adding entries to a control instruction buffer and adding pointers to a branch status table in accordance with specific embodiments of the inventions disclosed herein.

FIG. 6 provides an example of two bundles of instructions, one bundle of instructions including a control instruction, in accordance with specific embodiments of the inventions disclosed herein.

FIG. 7 provides an example of a first process of accessing a control instruction buffer and a second process of bypassing the control instruction buffer in accordance with specific embodiments of the inventions disclosed herein.

FIG. 8 provides an example of an instruction map with a branch misprediction in accordance with specific embodiments of the inventions disclosed herein.

FIG. 9 provides an example a branch misprediction in an instruction map showing different states of a branch status table and a control instruction buffer in accordance with specific embodiments of the inventions disclosed herein.

FIG. 10 provides an example of a method of rewinding a data structure to a point just before a misprediction in accordance with specific embodiments of the inventions disclosed herein.

FIG. 11 provides an example of decoder circuitry using an instruction pipeline control data entry for decoding an instruction in accordance with specific embodiments of the inventions disclosed herein.

FIG. 12 provides an example of updating a control instruction buffer and a branch status table to make space for additional data in accordance with specific embodiments of the inventions disclosed herein.

FIG. 13 provides an example of a processor including a branch status table and a control instruction buffer in accordance with specific embodiments of the inventions disclosed herein.

FIG. 14 provides an example of a method for using a branch status table and a control instruction buffer with a processor instruction pipeline in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for a branch status table and a control instruction buffer for use with a processor instruction pipeline in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to control instructions in computer processors are disclosed herein. In specific embodiments of the invention, methods and systems are provided that efficiently enforce execution of instructions with respect to the appropriate control instruction. In specific embodiments of the invention, a processor includes a branch status table and a control instruction buffer. The control instruction buffer can store a set of instruction pipeline control data entries in a set of addresses. The set of instruction pipeline control data entries can be the contents of control instructions. For example, in the context of a RISC-V processor, the control data entries can be the contents of a vset instruction. The branch status table may track the information of a stream of consecutive instructions. Each entry in the branch status table may correspond with a fetch bundle of instructions. A fetch bundle of instructions may also be referred to a fetch group of instructions, a set of instructions, a block of instructions, or a bundle of instructions. The fetch bundle may be a series of instructions appearing in program order and may include multiple not-taken branches and up to one taken branch. An entry in the branch status table may not track any branch instructions, may track one branch instruction, or may track multiple branch instructions depending on the fetch bundle of instructions that the entry refers to.

If the fetch bundle has multiple not-taken branches, it is possible that a mis-predicted branch will unwind some control instructions (e.g., vtype entries) but not others. To recover from the misprediction, the control instruction buffer may track program counter offset values (relative to the beginning of the fetch bundle) for each control instruction. The mis-predicted branch may also have an offset within the fetch bundle. When recovering, the pointer in the branch status table that points to the control instruction buffer may be used to begin the search, and then the offsets may be used to identify the last control instruction before the mis- predicted branch inside the fetch bundle.

In specific embodiments, the branch status table can store information regarding a set of pointers and a set of potential branches of the program or a fetch bundle of instructions (the bundle may include potential branches). The pointers can be in a one-to-one correspondence with the set of branches or the fetch bundle of instructions. The pointers can identify addresses in the control instruction buffer. The addresses identified by the pointers can store the oldest instruction pipeline control data entries that are associated with the branches that correspond with the pointers. Using the approaches disclosed herein, the entries in the control instruction buffer can be used to ensure that the appropriate control instruction is available for use by the instruction pipeline at any given time regardless of branch mispredictions, while at the same time minimizing the size of the branch status table as compared to alternative approaches.

In specific embodiments, the branch status table can be formed by a set of registers and can store a set of pointers in one-to-one correspondence with a set of branches. The branches from the set of branches can be branches which the instruction decode logic is predicting that the program will take in accordance with standard instruction processing pipelines that prefetch instructions before the path of the instructions is known to increase the efficiency of the pipeline. The branch status table can store data associated with a given branch or a given set of instructions in a register of the branch status table. Pointers in the set of pointers that correspond with branches or the set of instructions can be stored in the same register with the remaining data regarding their corresponding branch or set of instructions.

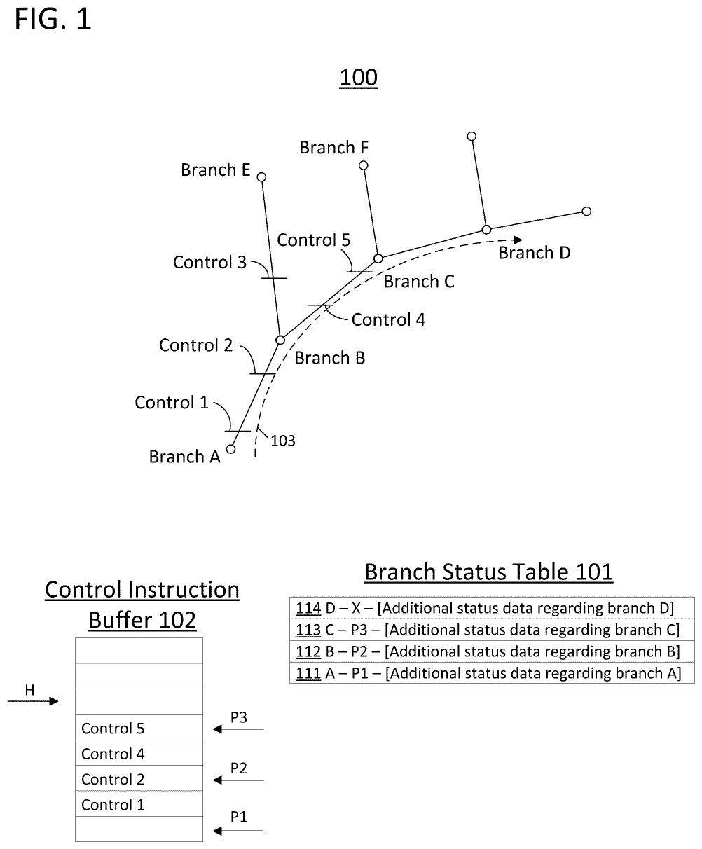

FIG. 1 illustrates an example of branch status table 101 and control instruction buffer 102 in the context of instruction map 100 in accordance with specific embodiments of the inventions disclosed herein. In instruction map 100, instruction path 103 is illustrated with a dotted line, branch instructions are illustrated as hollow circles, and control instructions are illustrated as short horizontal lines. Instruction path 103 may refer to the expected path of branches as predicted by branch prediction circuitry. As illustrated, the branch prediction circuitry may be expecting branch A to lead to branch B, branch B to lead to branch C, and branch C to lead to branch D.

Branch status table 101, as illustrated, includes four registers 111, 112, 113, and 114, though many more registers can be included in a branch status table depending upon how many branches are expected to be considered by the instruction pipeline at a given time. When a branch of instructions is committed to the processor for execution, the corresponding register of branch status table 101 can be used by other branches. That is, once a branch of instructions has moved to the next step of execution, the corresponding register of branch status table 101 may be deleted or written over. For example, if branch A goes to the processor, then register 111 corresponding to branch A may be rewritten with information about a new branch G. Each time the branch prediction circuitry makes another prediction, another branch can be added to branch status table 101, overwriting the oldest register. In the example of FIG. 1, the oldest register is register 111. Register 111 of branch status table 101 may also be deleted or written over if register 111 has otherwise been marked as obsolete (e.g., no longer needed). For example, if there is a branch misprediction.

As illustrated in branch status table 101, each register 111, 112, 113, and 114 includes an identifier for the branch (A, B, C, D respectively), a pointer that corresponds to the branch (P1, P2, P3 respectively, with no pointer for branch D yet), and additional status data regarding the respective branch. Branch D may not be associated with a pointer yet, as intervening control instructions between branch C and branch D may not have been decoded yet. The entries in branch status table 101 can be filled out as the path through the instructions is predicted by the branch prediction circuitry of the processor. As illustrated, the branch prediction circuitry may be expecting branch A to lead to branch B, branch B to lead to branch C, and branch C to lead to branch D. Each time the branch prediction circuitry makes another prediction, another branch can be added to branch status table 101.

FIG. 1 also illustrates an example of control instruction buffer 102. Control instruction buffer 102 stores a set of instruction pipeline control data entries in a set of addresses. The set of instruction pipeline control data entries can be the contents of control instructions (e.g., control instructions 1, 2, 4, and 5). For example, in the context of a RISC-V processor, the instruction pipeline control data entries can be the contents of a vset instruction. As such, the data in the control instruction buffer can be accessed similarly to a vtype configuration registers (CSR) for purposes of setting the configuration of the instruction pipeline. Control data entries can be added to control instruction buffer 102 in order as the configuration instructions are decoded by the instruction pipeline. In specific embodiments, whenever a new control instruction is decoded, the content of the instruction can be stored as the control data entry in control instruction buffer 102 at the top of control instruction buffer 102. In specific embodiments, whenever a new control instruction is decoded, the content of the instruction can be stored as the control data entry in control instruction buffer 102 at an address identified by a head pointer H. The head pointer can then be incremented by one so that the next control data entry is stored in the next available address. In specific embodiments, the configuration instructions may be numerically ordered and tagged by the decode logic to assure that they are stored into control instruction buffer 102 in order.

The pointers (P1, P2, P3) that are stored in branch status table 101 can identify addresses in a set of addresses of control instruction buffer 102. The pointers can also be associated with branches (A, B, C, D) in a correspondence. For example, the pointers can be stored in a register (of branch status table 101) associated with the branch. The set of pointers can identify addresses, in the set of addresses, which store the most recent instruction pipeline control data entries which proceed the branches that correspond with the pointers. For example, in FIG. 1, pointer P2 corresponds with branch B because it is stored in the same register as an identifier for branch B and status data for branch B. Pointer P2 also identifies an address in control instruction buffer 102 which stores the most recent instruction pipeline control data entry to the branch it corresponds with. As illustrated, pointer P2 identifies an address in control instruction buffer 102 which stores an instruction pipeline control data entry for control instruction 2, and the instruction pipeline control data entry of control instruction 2 is the most recent instruction pipeline control data entry which proceeds branch B.

In specific embodiments of the invention, the entries in control instruction buffer 102 are added as the instructions are decoded by the instruction pipeline and the branch prediction circuitry predicts which branches will be taken by the program that is being executed by the instruction pipeline. In specific embodiments, an instruction decoder will be configured to store an instruction pipeline control data entry of a control instruction in control instruction buffer 102 when the control instruction is decoded. The instruction decoder may also be configured to add a pointer from the set of pointers to branch status table 101 when a branch is predicted and the control instruction is decoded. In other words, the instruction pipeline control data entries can be added to control instruction buffer 102 as soon as they are decoded by the decoder. However, in specific examples, the pointer will not be added to branch status table 101 until the branch has been predicted and the instruction is decoded.

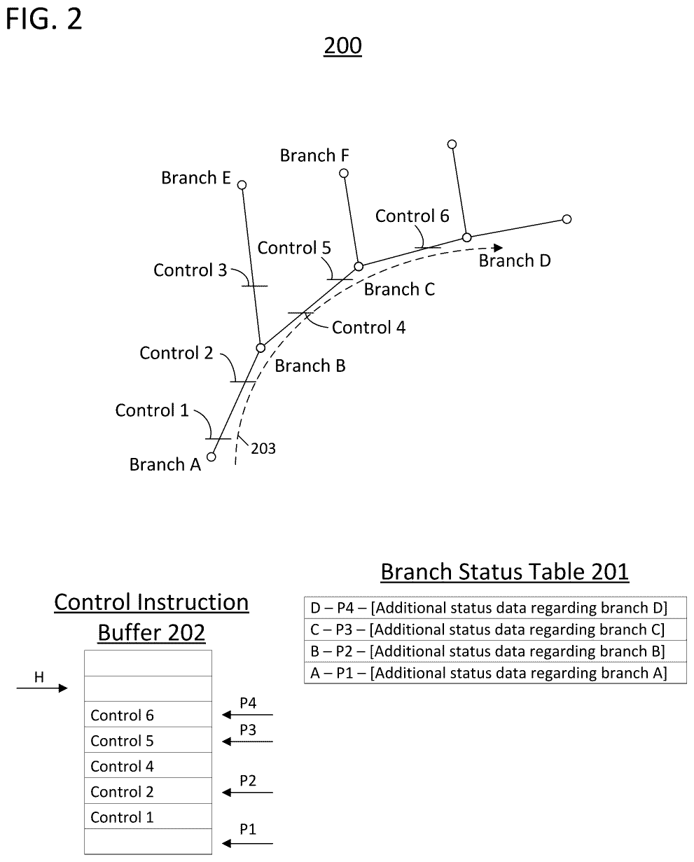

FIG. 2 illustrates an example of branch status table 201 and control instruction buffer 202 in the context of instruction map 200 in accordance with specific embodiments of the inventions disclosed herein. In instruction map 200, instruction path 203 is illustrated with a dotted line, branch instructions are illustrated as hollow circles, and control instructions are illustrated as short horizontal lines. Instruction path 203 may refer to the expected path of branches as predicted by branch prediction circuitry. FIG. 2 may be similar to FIG. 1 but may include an additional decoded control instruction, control instruction 6, in control instruction buffer 202 and a pointer, P4, associated with branch D, in branch status table 201.

A comparison of FIG. 1 and FIG. 2 illustrates how entries can be added to the control instruction buffer and pointers can be added to the branch status table. In FIG. 1, a head pointer (H) of control instruction buffer 102 identifies the next available space for storing instruction pipeline control data entries. Furthermore, branch D has been predicted as a branch that will be taken by the program that is being executed by the processor. However, no control instructions have been decoded that are between branch C and branch D. In FIG. 2, a control instruction in the form of control instruction 6 has been decoded. Accordingly, the instruction pipeline control data entry that is represented by control instruction 6 has been stored at the next available location in control instruction buffer 202, the head pointer (H) has been incremented by one, and a pointer (P4) to the address storing the instruction pipeline control data that is represented by control instruction 6 has been stored in branch status table 201 in correspondence with branch D. The control instruction buffer and branch status table can continue to be built in this fashion as branches are predicted and control instructions are decoded.

In an alternative approach, the instruction pipeline control data entries could be stored in the branch status table. However, in these approaches each entry in the branch status table would need to be designed to store the worst-case theoretical number of control instructions that can be implicated by the path to that branch. In the context of instructions which set the vtype register of a RISC-V processor, the theoretical number of control instructions is eight, which would lead to a massive increase in the size of the branch status table with many of the entries not being used as paths between branches would generally not face the worst-case theoretical requirement. If instead the control instruction data entries are stored in a control instruction buffer, each entry of the branch status table can correspond to an arbitrary number of control instructions.

In specific embodiments of the invention, a processor will include an instruction execution pipeline that is coupled to the control instruction buffer. The most recent entry in the control instruction buffer can be used by the instruction execution pipeline to set the configuration of the instruction pipeline when executing instructions. In the context of a RISC-V processor, the instruction execution pipeline could use a most recent entry to the control instruction buffer as a vtype register. The instruction execution pipeline could be configured to access a most recent entry to the control instruction buffer when executing instructions. The instruction execution pipeline could utilize a head pointer of the control instruction buffer for this purpose. In specific embodiments, the most recent entry can be identified using the head pointer of the control instruction buffer such as by accessing the entry that is one address less than the address identified by the head pointer.

In specific embodiments, the processor can read the most recent entry from the control instruction buffer when decoding instructions. The instruction pipeline control data entry can be used by the decoder circuitry for decoding the number of micro-operations in an instruction and then decoding the micro-operations themselves. The instruction pipeline control data entry can then be appended to the decoded micro-operations by the decoder when they are dispatched to the next stage of the instruction pipeline (e.g. the midcore of a processor). As such, subsequent portions of the instruction pipeline will not need to access the control instruction buffer to determine how to configure the instruction pipeline for the execution of the micro-operations. Furthermore, the state of the control instruction buffer can be modified without needing to maintain the identity of the instruction pipeline control data entry and its association with the instruction as it is being processed further.

In specific embodiments, the instruction pipeline processes instructions in bundles. For example, the decoder circuitry could decode instructions in bundles. The processor could therefore include a bundle of instructions. The bundle of instructions could include a control instruction. In specific embodiments, the instruction pipeline can be configured to access either the control instruction buffer or use a control instruction from the bundle of instructions depending on whether the instruction bundle includes a control instruction. The decode logic could be configured to detect when a bundle includes a control instruction and execute logic that bypassed an access to the control instruction buffer and instead utilize a control instruction in the same instruction bundle. In specific embodiments, when decoding instructions, the processor can read the most recent entry from the control instruction buffer if there is no more recent control instruction in the fetch bundle.

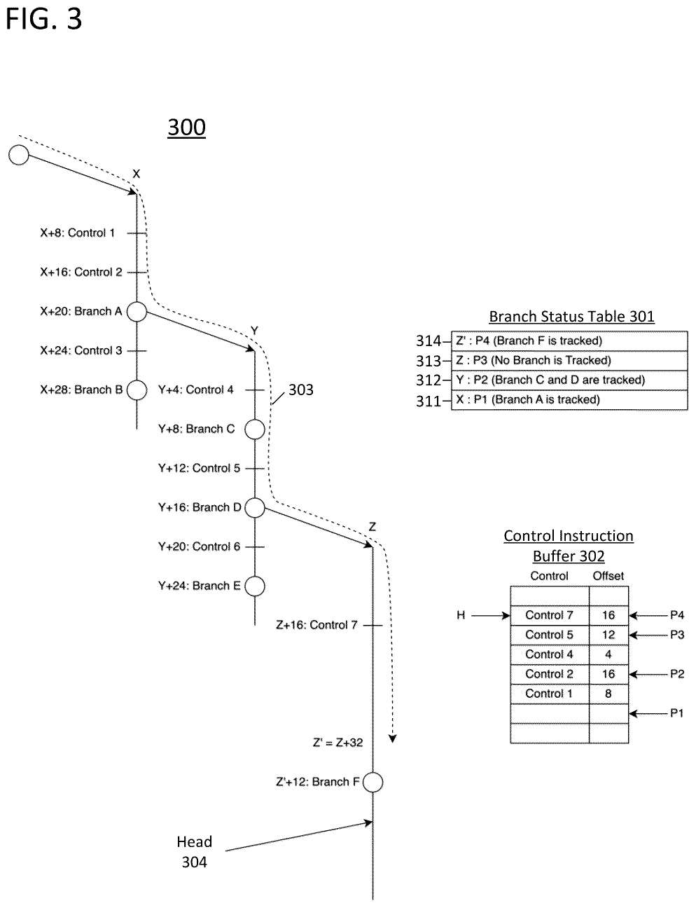

FIG. 3 illustrates an example of four fetch groups X, Y, Z, and Z′ in instruction map 300 in accordance with specific embodiments of the inventions disclosed herein. Each fetch group may contain one or more branches (fetch group X contains branch instruction A; fetch group Y contains branch instructions C and D). In instruction map 300, instruction path 303 is illustrated with a dotted line, branch instructions are illustrated as hollow circles, and control instructions are illustrated as short horizontal lines. Instruction path 303 may refer to the expected path of branches as predicted by branch prediction circuitry. Branch status table 301 may include four registers 311, 312, 313, and 314.

Each entry in branch status table 301 may track information of a fetch group. A fetch group may represent a set of instructions or a block of instructions and may include both control and branch instructions. The block of instructions may be a series of instructions appearing in program order. The block of instructions may contain more than one instruction and the block of instructions can be terminated by various conditions. For example, a block of instructions may be terminated if a branch is taken (e.g., a discontinuation point), if a maximum quantity of instructions in a fetch group is met, if a maximum quantity of total instruction bytes in a fetch group is met, if there is a mis-predicted branch, if the instruction pipeline is flushed (e.g., a corner case is hit), if there is a microarchitecture retry event (e.g., ordering violation), or if certain instructions are received, decoded, or executed (e.g., FENCE.I for RISC-V ISA). A fetch group may be speculatively generated in the frontend of the instruction pipeline based on branch prediction information. If a branch misprediction is detected later in the pipeline, the fetch group may be adjusted (e.g., based on the fetch group restrictions).

The four fetch groups may be ordered X, Y, Z, and Z′, each of which may be associated with pointers P1, P2, P3, and P4 respectively. Fetch group Z′ may be considered a fetch group as there are no fetch group terminate instructions between Z+0 to Z+31 and fetch group Z may have reached a maximum size. This enforces the termination of fetch group Z and the beginning of new fetch group Z′ at Z+32. In the example of FIG. 3, fetch group X may stand for the fetch group starting from where the program counter (PC) is equal to X.

Branch status table 301 may include four registers 311, 312, 313, and 314. Branch status table 301 may track branches that are part of instruction path 303 in registers with the corresponding fetch groups. Each fetch group may also be associated with a pointer. For example, register 311 may include information about fetch group X, such as pointer P1 and tracking information about branch instruction A. As branch instruction A is along instruction path 303 while branch instruction B is not, instruction A may be tracked in branch status table 301 while branch instruction B is not. Register 312 may include information about fetch group Y, such as pointer P2 and tracking information about branch instructions C and D. As both branch instructions C and D are along instruction path 303, they may both be tracked in branch status table 301.

Control instruction buffer 302 can store a set of instruction pipeline control data entries in a set of addresses. The set of instruction pipeline control data entries can be the contents of control instructions. Control instruction 1, 2, 4, 5, and 7 may be tracked in control instruction buffer 302, as control instructions 1, 2, 4, 5, and 7 may be the control instructions that are predicted to be implemented. Control instructions 3 and 6 and may not be predicted to be implemented and accordingly control instructions 3 and 6 (or instruction control pipeline data entries associated with control instructions 3 and 6) may not be stored in control instruction buffer 302. Control instruction buffer 302 may track control instruction information and instruction address offset from the beginning of the fetch group. For example, control instruction 1 is a control instruction belonging to fetch group X and the instruction address of control instruction 1 is X+8. In such a case, control instruction 1 is saved with its offset (8) in control instruction buffer 302. Both control instruction 1 and control instruction 2 (with their respective offsets) are recorded in control instruction buffer 302 as both control instructions are part of fetch group X and are predicted to be implemented.

Each fetch group may be associated with a pointer. This correspondence may be tracked in branch status table 301. Fetch group X may be associated with P1 and track branch A, fetch group Y may be associated with P2 and track branches C and D, fetch group Z may be associated with pointer P3 and may not track (e.g., refrain from tracking) any branches, and fetch group Z′ may be associated with P4 and track branch F. The pointers may point to instruction pipeline control data entries in control instruction buffer 302. Each pipeline control data entry may be associated with a control instruction. Each pointer may refer to the last control instruction of the fetch group previous to the fetch group stored in association with the pointer in branch status table 301. For example, P3 of fetch group Z points to an instruction control data entry that is the contents of control instruction 5, control instruction 5 being the last control instruction in fetch group Y that is on instruction path 303 (e.g., that is predicted to be implemented). The header pointer H points to a last written entry of control instruction buffer 302 or to a first available (e.g., empty, content marked for deletion) address. Head 304 of instruction map 300 may refer to the furthest instruction that the instruction circuitry has so far predicted.

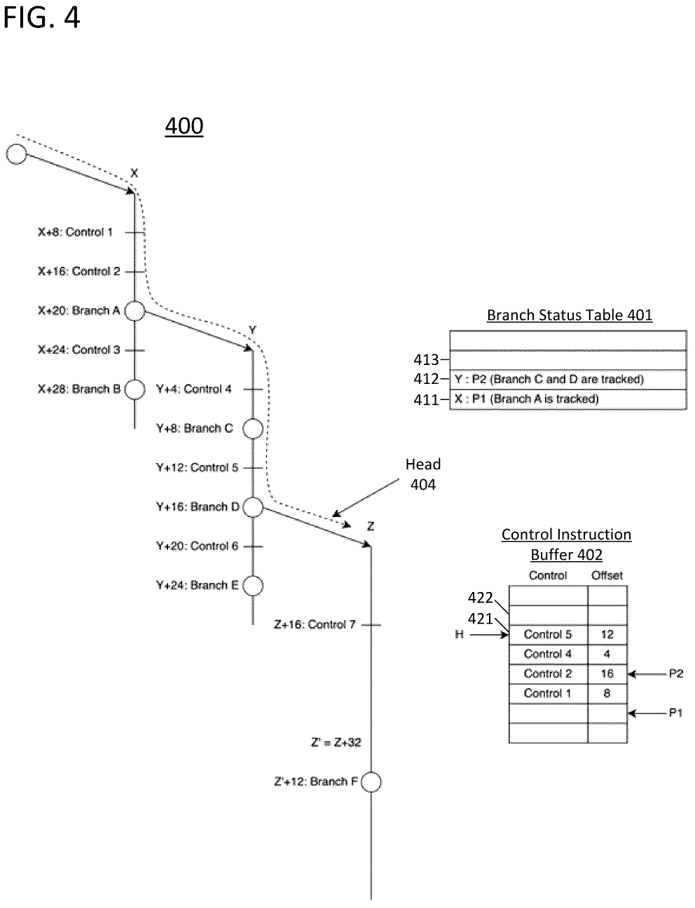

FIG. 4 illustrates an example of adding entries to a control buffer and a branch status table when fetching a fetch group of instructions in accordance with specific embodiments of the inventions disclosed herein. FIG. 4 may be related to FIG. 3, where FIG. 4 is a step in the process of filling up the branch status table and the control instruction buffer of FIG. 3. In FIG. 4, two fetch groups X and Y may be recorded in branch status table 401 (at registers 411 and 412 respectively) and control instruction buffer 402 may include instruction pipeline control data entries related to control instructions 1, 2, 4, and 5. Head 404 of instruction map 400 may refer to the furthest instruction that the instruction circuitry has so far predicted, which, in the example of FIG. 4, is up to fetch group Z.

In the example of FIG. 4, a CPU may have already processed fetch groups X and Y (thus they are recorded in branch status table 401). The CPU may then fetch fetching group Z because a branch predictor for branch D indicates that branch D is likely jumping into fetching group Z. In this case, when the first control instruction located at Z (control instruction 7) is fetched, the branch status table entry for Z may be assigned, for example to register 413. When the first instruction of fetch group Z (instruction at Z+0) is processed at decode, the header pointer (H) of control instruction buffer 402, which is pointing to control instruction 5 in the example of FIG. 4, may be copied into register 413 as a third pointer (P3).

After the instruction at Z+0 is decoded and register 413 is assigned to fetch group Z, control instruction 7 (e.g., at Z+16) may be decoded. When control instruction 7 is decoded, the pipeline may increment header pointer H from address 421 to address 422 and may assign control instruction 7 to control instruction buffer 402 at address 422. The decode logic may not process instructions when the oldest branch status table entry is tracking control instruction buffer H+1. In other words, the decode logic may refrain from processing additional instructions if the control instruction buffer is full. When control instruction 7 is added to control instruction buffer 402, the offset (16) of control instruction 7 may also be added to control instruction buffer 402.

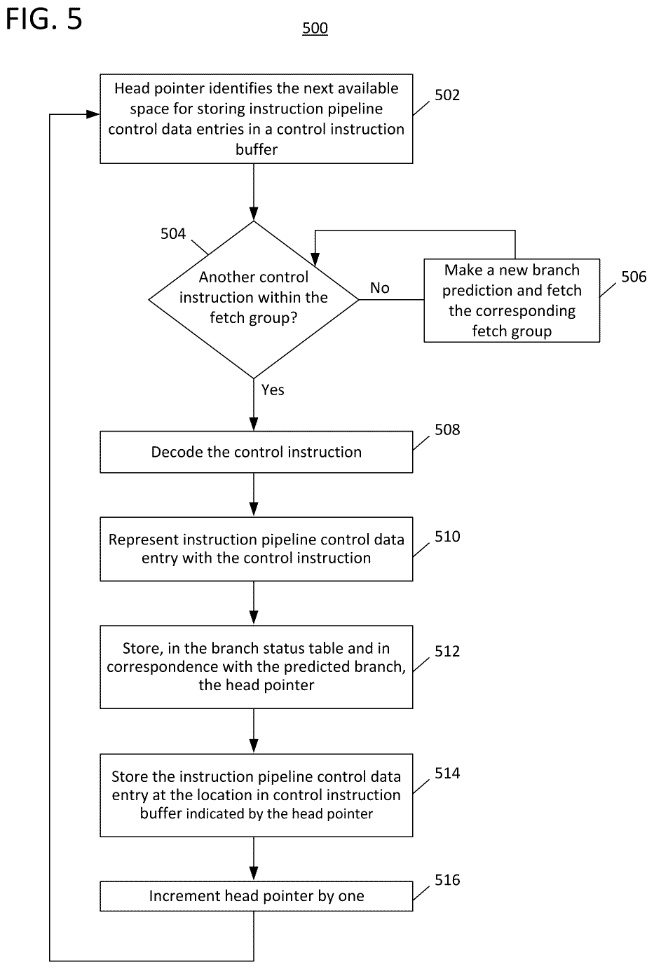

FIG. 5 illustrates an example of method 500 for adding entries to a control instruction buffer and adding pointers to a branch status table in accordance with specific embodiments of the inventions disclosed herein. Steps or portions of steps of method 500 may be duplicated, rearranged, omitted, or otherwise deviate from the form shown. In specific embodiments, additional steps may be added to method 500. In specific embodiments, portions of method 500 may be performed in parallel or may overlap such that multiple instructions are processed at once. Multiple instructions may be processed such that the same step of method 500 is performed for multiple instructions at the same time or such that instructions are at different steps of method 500 at the same time. That is, a processor may not wait until the completion of method 500 for a first before starting to process a second instruction also using method 500.

At step 502, a head pointer identifies the next available space for storing instruction pipeline control data entries in a control instruction buffer.

At step 504, whether there is another control instruction within the fetch group may be determined. If there are no more control instructions within the fetch group then the process may continue to step 506. If there is another control instruction within the fetch group then the process may continue to step 508.

If there are no more control instructions within the fetch group, at step 506, a new branch may be predicted and the corresponding fetch group may be fetched. For example, branch prediction circuitry may predict that a branch in a previous fetch group will be taken and a new fetch group may be fetched, or the previously fetched fetch group may otherwise be terminated (e.g., reached a max size, pipeline flush, etc.). The branch prediction circuitry may fetch a new fetch group corresponding to the predicted branch and may repeat step 504. That is, branch predictions may be made and fetch groups may be fetched until a control instruction is predicted, until the pipeline flushes, or until the program completes (e.g., there are no further instructions).

If there is another control instruction within the fetch group then, at step 508, the control instruction may be decoded. The control instruction may be part of the predicted branch.

At step 510, instruction pipeline control data entry may be generated. The instruction pipeline control data may be representative of the control instruction (e.g., decoded at step 508).

At step 512, the head pointer may be stored in the branch status table (e.g., as P1) in a register corresponding to the predicted fetch group. Accordingly, the head pointer may point to the address that stores the instruction pipeline control data that is representative of the control instruction.

At step 514, the instruction pipeline control data may be stored in the branch status table in correspondence with the predicted branch. The instruction pipeline control data may be stored at the next available location in the control instruction buffer, as indicated by the header pointer. Step 514 may occur before, during, or after step 512.

At step 516, the head pointer may be incremented by one. The head pointer may then, accordingly, point to the next available location in the control instruction buffer.

After step 516, the process may loop back to step 502. In this way, the control instruction buffer and branch status table can continue to be built as branches are predicted and control instructions are decoded.

The most recent entry in the control instruction buffer can be used by the instruction execution pipeline to set the configuration of the instruction pipeline when executing instructions. In specific embodiments, the most recent entry can be identified using the head pointer of the control instruction buffer such as by accessing the entry that is one address less than the address identified by the head pointer. The entries in the control instruction buffer can be used to ensure that the appropriate control instruction is available for use by the instruction pipeline at any given time regardless of branch mispredictions, while at the same time minimizing the size of the branch status table.

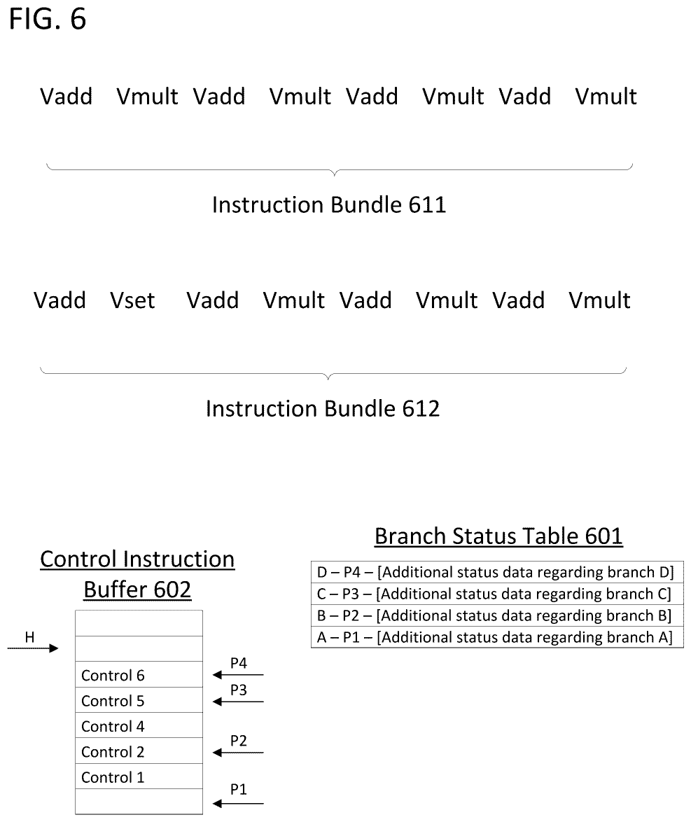

FIG. 6 illustrates instruction bundle 611, instruction bundle 612, control instruction buffer 602, and branch status table 601 in accordance with specific embodiments of the inventions disclosed herein. Instruction bundle 611 (e.g., a first bundle of instructions) is only vector multiplications and vector additions and it does not include any control instructions. Instruction bundle 612 (e.g., a second bundle of instructions) includes vector multiplications and vector additions and includes a control instruction in the form of a Vset instruction which will impact the configuration of the instruction execution pipeline. In specific embodiments, instruction bundle 611 is executed before instruction bundle 612. The instruction execution pipeline can be configured to use a control instruction from the bundle of instructions, when executing the bundle of instructions, if any control instruction is in the bundle of instructions; and access a most recent entry to the control instruction buffer, when executing the bundle of instructions, if there are no control instructions in the bundle of instructions. Accordingly, the instruction pipeline can be configured to use the instruction pipeline control data entry at pointer P4 in control instruction buffer 602 when decoding instruction bundle 611 in FIG. 6, but use the instruction pipeline control data entry represented by the Vset instruction and bypass the logic associated with accessing control instruction buffer 302 when decoding instruction bundle 612 in FIG. 6. This ability to bypass the aforementioned logic can be useful in embodiments in which the instruction pipeline control data entries are added to the control instruction buffer during the decoding of the instructions as the data may not be available when decoding an instruction bundle that includes control instructions since they have not yet been fully decoded.

Beneficially, when a branch misprediction occurs, the data structure can effectively be rewound to a point just before the misprediction with minimal overhead. Generally, the process can involve detecting a branch misprediction, such as by using an instruction decoder, and resetting a head pointer of the control instruction buffer to an address associated with the newest configuration instruction that was not on the branch misprediction. In specific embodiments of the invention, the correct pointer will already be stored in the branch status table in the entry associated with the mis-predicted branch. Upon detecting a mis-prediction, the processing pipeline can be flushed, and the head pointer of the control instruction buffer can be set to the pointer value that corresponds to the last correctly predicted branch.

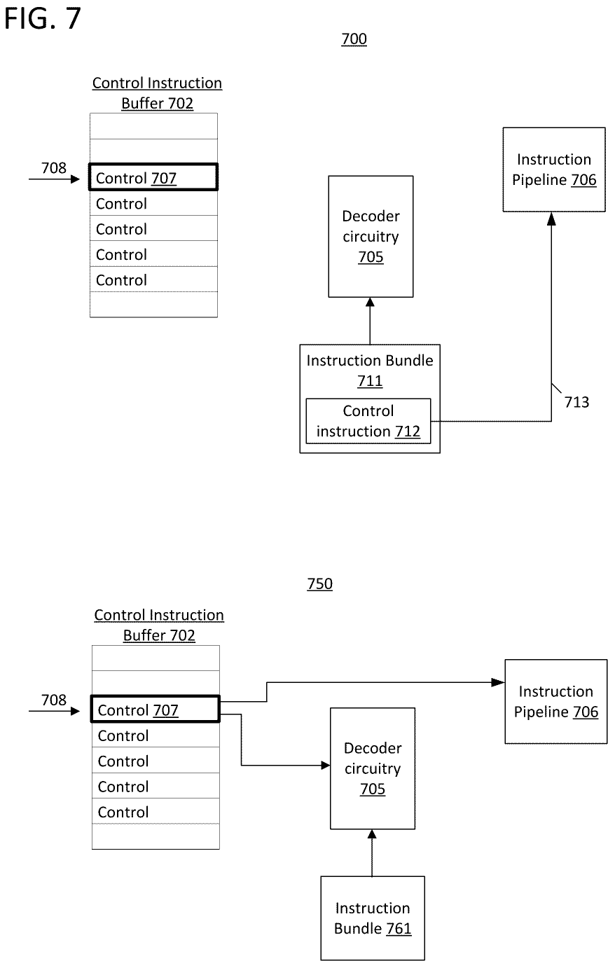

FIG. 7 illustrates an example of process 700 including bypassing control instruction buffer 702 and process 750 including accessing control instruction buffer 702 in accordance with specific embodiments of the inventions disclosed herein. In specific embodiments, instruction pipeline 706 processes instructions in bundles. For example, the decoder circuitry could decode instructions in bundles. The processor could therefore include a bundle of instructions such as instruction bundle 711 and instruction bundle 761. Instruction bundle 711 could include control instruction 712. In specific embodiments, instruction pipeline 706 can be configured to access either control instruction buffer 702 (in process 750) or use control instruction 712 from instruction bundle 711 (in process 700). Whether instruction pipeline 706 access or bypasses control instruction buffer 702 depends on whether the instruction bundle includes a control instruction. Decoder circuitry 705 (e.g., decode logic) could be configured to detect when a bundle includes a control instruction and execute logic that bypasses an access to control instruction buffer 702 and instead utilizes a control instruction in the same instruction bundle. In specific embodiments, when decoding instructions, the processor can read the most recent entry from control instruction buffer 702 if there is not a control instruction in the fetch bundle that is more recent than the most recent entry from control instruction buffer 702.

FIG. 7 illustrates process 700 and process 750, each using control instruction buffer 302, decoder circuitry 705, and instruction pipeline 706 (e.g., an instruction execution pipeline). Process 700 includes instruction bundle 711 with control instruction 712 and bypass path 713. Process 750 includes instruction bundle 761, which may not include any control instructions. For example, instruction bundle 761 may include only vector multiplications and vector additions. Instruction bundle 711 may include vector multiplications and vector additions as well as control instruction 712. Control instruction 712 may be a Vset instruction which may impact the configuration of instruction pipeline 706. Instruction pipeline 706 can be configured to use control instruction 712 from instruction bundle 711, when executing instruction bundle 711. Instruction pipeline 706 can be configured to access a most recent entry (entry 707) of control instruction buffer 702, when executing instruction bundle 761, as there are no control instructions in instruction bundle 761. Accordingly, instruction pipeline 706 can be configured to use instruction pipeline control data entry 707 at pointer 708 in control instruction buffer 702 when decoding instruction bundle 761, but use the instruction pipeline control data entry represented by the control instruction 712 and bypass the logic associated with accessing control instruction buffer 702 when decoding instruction bundle 711. This ability to bypass the aforementioned logic can be useful in embodiments in which the instruction pipeline control data entries are added to the control instruction buffer during the decoding of the instructions as the data may not be available when decoding an instruction bundle that include control instructions since they have not yet been fully decoded.

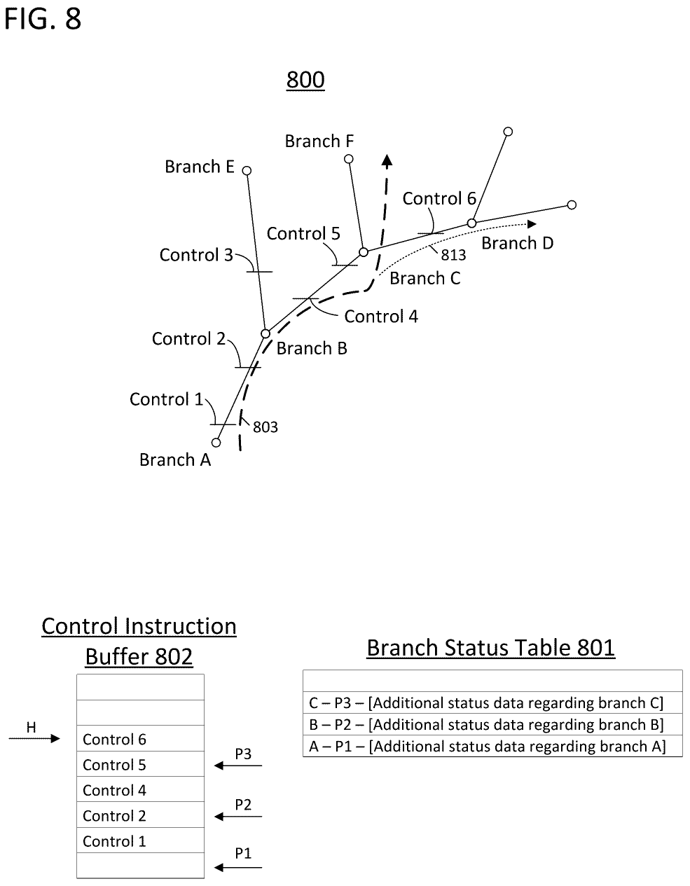

FIG. 8 illustrates an example of instruction map 800 with a branch misprediction in accordance with specific embodiments of the inventions disclosed herein. Instruction path 803 represents the correct instruction path while instruction path 813 represents a misprediction. In specific embodiments of the invention, the approaches disclosed herein are beneficial in that the correct pointer will already be stored in the branch status table in the entry associated with the mis-predicted branch. Upon detecting a mis-prediction, the processing pipeline can be flushed, and the head pointer of the control instruction buffer can be set to the pointer value that corresponds to the last correctly predicted branch.

In FIG. 8, a branch misprediction has occurred as the decoder determined that instruction path 813 from branch C to branch D is incorrect and that the correct instruction path 803 is moving to branch F from branch C. Accordingly, the head pointer H can be moved to one address after the pointer that corresponds with the last correctly predicted branch, which in this case is P3 as corresponding to branch C. As illustrated, the instruction pipeline will access the control data associated with control instruction 5 when executing the next instructions since that is the instruction that is one address behind the head pointer H in control instruction buffer 802. Furthermore, the next time a control instruction is received, the new control instruction will be written over the control data associated with control instruction 6. Thus, control instruction buffer 802 has been placed into the appropriate state by moving a single pointer in accordance with data that was stored in branch status table 801.

In specific embodiments of the invention, when a branch of instructions is committed to the instruction pipeline, such as by being decoded into micro-operations which are dispatched for execution, the control instruction buffer and branch status table can be updated to reflect the fact that the instructions have passed beyond the scope of their record keeping and space can be made for additional data. Specifically, when a branch of instructions is committed to the instruction pipeline, one or more instruction pipeline control data entries that are associated with the branch can be marked for deletion in the control instruction buffer. In specific embodiments of the invention, the control instruction buffer can be a circular buffer and addresses associated with committed instruction branches can subsequently be overwritten by data for new branch predictions as the stack of instruction pipeline control data entries loops back through the buffer.

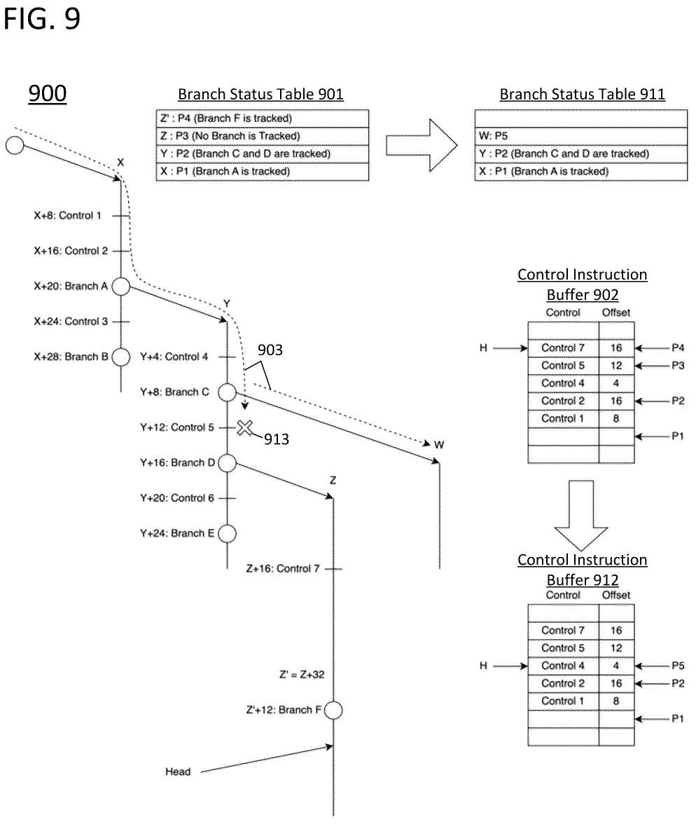

FIG. 9 illustrates an example of a branch misprediction in instruction map 900, showing different states of a branch status table and a control instruction buffer, in accordance with specific embodiments of the inventions disclosed herein. Instruction path 903 represents the correct instruction path while point 913 represents the start of the misprediction. The branch misprediction occurs at branch C. According to the misprediction, branch C is not taken while in the correct instruction path 903 takes branch C. Branch status table 901 is an example of a branch status table before the misprediction is detected while branch status table 911 is an example of a branch status table after the misprediction is detected and corrected. Control instruction buffer 902 is an example of a control instruction buffer before the misprediction is detected and control instruction buffer 912 is an example of a control instruction buffer after the misprediction is detected and corrected.

Due to the prediction of not taking Branch C, fetch groups Z and Z′ were speculatively fetched and information about them was stored in branch status table 901. Additionally, pointers P2 and P3, associated with fetch groups Y and Z respectively, were assigned to addresses in control instruction buffer 902. The pipeline had access to the fetch group where the misprediction occurred (fetch group Y) and the entry in branch status table 901 associated with that fetch group (entry Y) and next entry in branch status table 901 (entry Z). The pipeline accordingly had access to control instruction buffer pointers P2 and P3.

After detecting the misprediction, the pipeline may check addresses in control instruction buffer starting at P2 (the pointer associated with fetch group Y, the last correct fetch group) and incrementing (checking addresses P2+1, P2+2, . . . P3) to determine which offset saved in control instruction buffer 902 is larger than the offset of the mis-predicted branch (Branch C offset is 8 in FIG. 9). In this case, the largest entry number whose offset is smaller than mis-predicted branch is P2+1 (with an offset of 4 and referring to control instruction 4, the last correct control instruction). The head pointer returns to this address (here, P2+1), as illustrated in control instruction buffer 912. After the head pointer is reset (e.g., unrolled), there may be a frontend restart fetch from the restarted point (in this example, branch target of branch C). When the replay event happens at Y+8, the pipeline may be unrolled and restart from the instruction at address Y+8 or a next instruction from address Y+8 depending on the reply (flush or resync) condition.

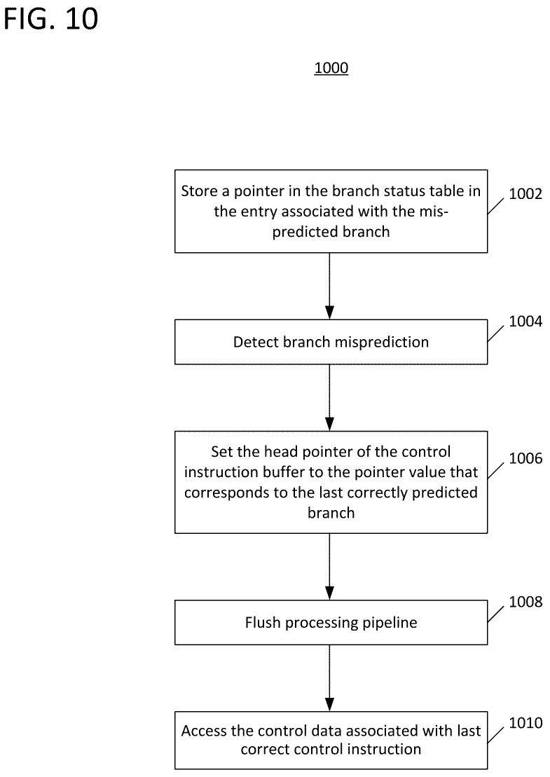

FIG. 10 illustrates an example of method 1000 of rewinding a data structure to a point just before a misprediction in accordance with specific embodiments of the inventions disclosed herein. When a branch misprediction occurs, the data structure can effectively be rewound to a point just before the misprediction with minimal overhead. Generally, the process can involve detecting a branch misprediction, such as by using an instruction decoder, and resetting a head pointer of the control instruction buffer to an address associated with the newest configuration instruction that was not on the branch misprediction. Steps or portions of steps of method 1000 may be duplicated, rearranged, omitted, or otherwise deviate from the form shown. In specific embodiments, additional steps may be added to method 1000. In specific embodiments, portions of method 1000 may be performed in parallel, in series, or may overlap.

At step 1002, a pointer may be stored in the branch status table in the entry associated with the mis-predicted branch.

At step 1004, a mis-prediction may be detected. For example, a branch misprediction may be detected as the decoder determines that the actual instruction path goes to branch C from branch A instead of to predicted branch B from branch A.

At step 1006, the head pointer of the control instruction buffer may be set to the pointer value that corresponds to the last correctly predicted branch. Accordingly, the head pointer H can be changed to point to an address after the pointer that corresponds with the last correctly predicted branch (in this example, branch A). In other words, the header pointer of the control buffer may be reset to an address one address ahead of the address of the newest configuration instruction that was not on the mis-predicted branch. In specific embodiments, the head pointer may correspond to an incorrect prediction (e.g., in branch B). The head pointer being at this address may indicate that the information stored in the control buffer at this address may be deleted or written over.

At step 1008, the processing pipeline may be flushed. The processing pipeline may have been executing incorrect or unnecessary instructions.

At step 1010, when executing the next instructions, the instruction pipeline may access the control data associated with the instruction that is one address behind the head pointer in the control instruction buffer. The control data may be associated with the address of the newest configuration instruction that was not on the mis-predicted branch. The next time a control instruction is received it may be written over the control data associated with a mis-predicted control instruction (e.g., as indicated by the head pointer). Thus, the control instruction buffer may be placed into the appropriate state by moving a single pointer in accordance with data that was stored in the branch status table and the data structure can effectively be rewound to a point just before the misprediction with minimal overhead.

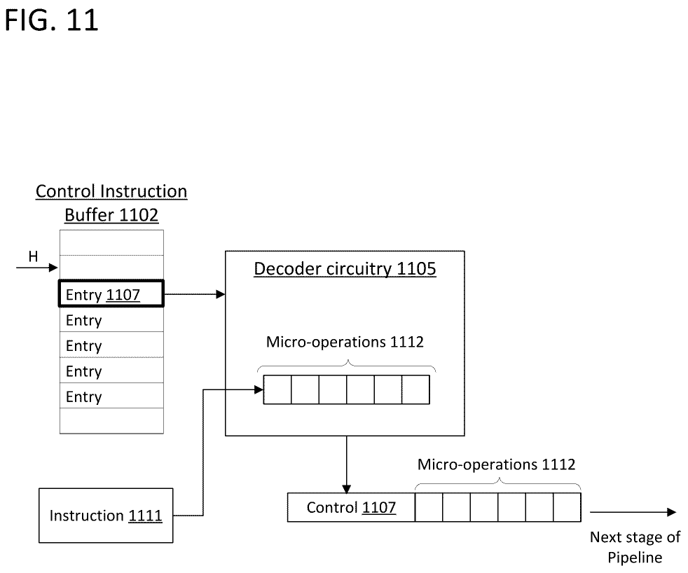

FIG. 11 illustrates an example of decoder circuitry 1105 using instruction pipeline control data entry 1107 for decoding instruction 1111 in accordance with specific embodiments of the inventions disclosed herein. Instruction pipeline control data entry 1107 may represent, or be represented by, a control instruction.

A processor can read the most recent entry, entry 1107, from control instruction buffer 1102 when decoding instructions. Instruction pipeline control data entry 1107 can be used by decoder circuitry 1105 for decoding the number of micro-operations 1112 in instruction 1111 and then decoding the micro-operations 1112 themselves. Instruction pipeline control data entry 1107 can then be appended to the decoded micro-operations 1112 by decoder circuitry 1105 when they are dispatched to the next stage of the instruction pipeline (e.g. the midcore of a processor). As such, subsequent portions of the instruction pipeline will not need to access control instruction buffer 1102 to determine how to configure the instruction pipeline for the execution of micro-operations 1112. Furthermore, the state of control instruction buffer 1102 can be modified without needing to maintain the identity of the instruction pipeline control data entry 1107 and its association with instruction 1111 as it is being processed further.

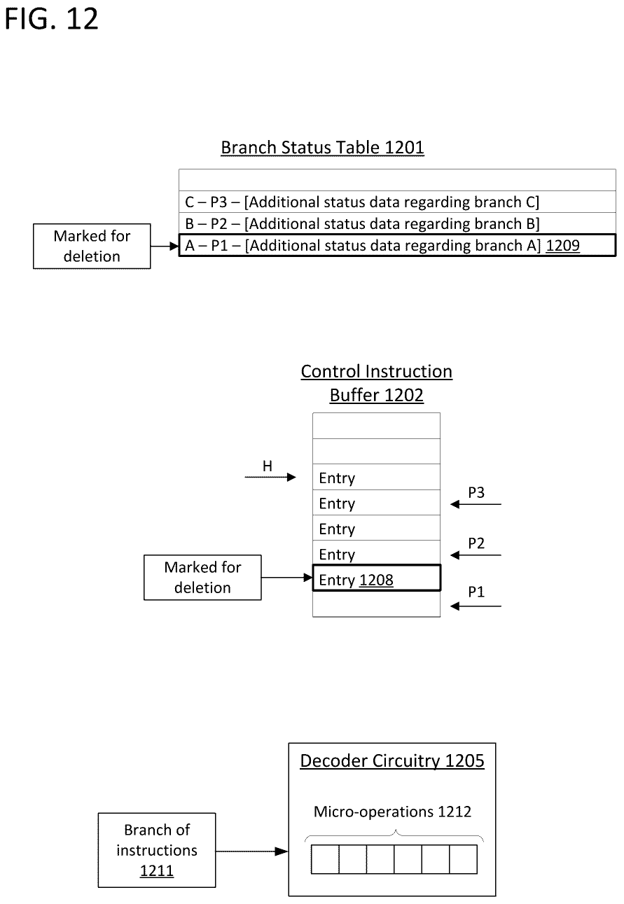

FIG. 12 illustrates an example of updating control instruction buffer 1202 and branch status table 1201 to make space for additional data in accordance with specific embodiments of the inventions disclosed herein. Branch of instructions 1211 may be committed to the instruction pipeline. Branch of instructions 1211 may be associated with branch A and pointer P1. Branch A may have been predicted correctly by branch prediction circuitry.

In the example of FIG. 12, branch of instructions 1211 may be committed to the instruction pipeline. Branch of instructions 1211 may be committed to the instruction pipeline by being decoded into micro-operations 1212 by decoder circuitry 1205. Micro-operations 1212 may be dispatched for execution. Control instruction buffer 1202 and branch status table 1201 may be updated to reflect the fact that branch of instructions 1211 has been committed to the instruction pipeline and therefore passed beyond the scope of their record keeping. Control instruction buffer 1202 and branch status table 1201 may be updated such that space may be made for additional data.

When branch of instructions 1211 is committed to the instruction pipeline, register 1209, which is associated with branch of instructions 1211, may be marked for deletion in branch status table 1201. When branch of instructions 1211 is committed to the instruction pipeline, instruction pipeline control data entry 1208, which is associated with branch of instructions 1211, may be marked for deletion in control instruction buffer 1202. In specific embodiments of the invention, control instruction buffer 1202 can be a circular buffer and addresses associated with committed instruction branches can subsequently be overwritten by data for new branch predictions as the stack of instruction pipeline control data entries loops back through the buffer. In specific embodiments, decoder circuitry 1205 may not process instructions when the oldest branch status table entry is tracking control instruction buffer H+1. In other words, the decode logic may refrain from processing additional instructions if the control instruction buffer is full.

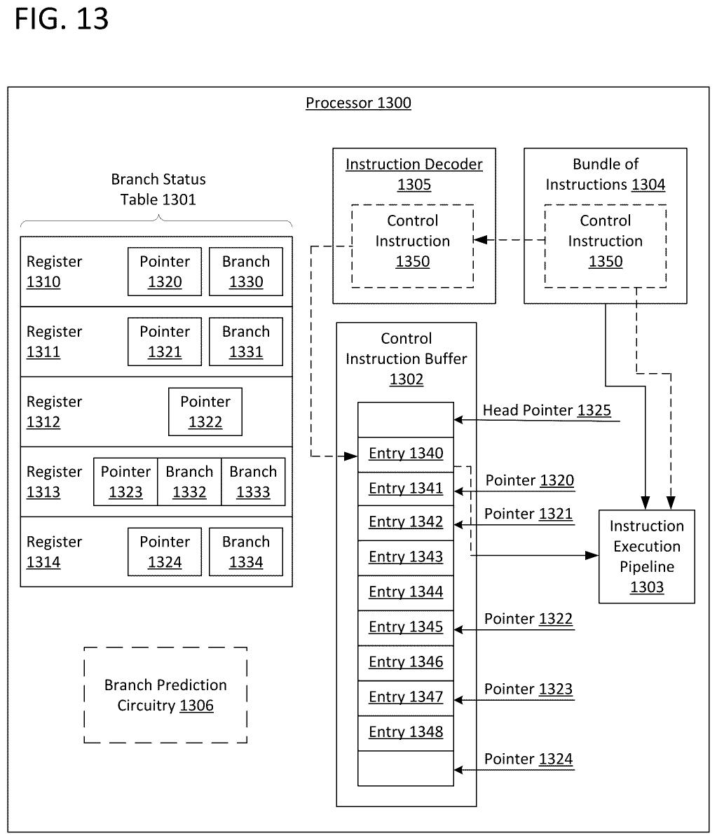

FIG. 13 illustrates an example of processor 1300 including branch status table 1301 and control instruction buffer 1302 in accordance with specific embodiments of the inventions disclosed herein. Processor 1300 may include branch status table 1301 and control instruction buffer 1302. In specific embodiments, processor 1300 is a RISC-V processor. In specific embodiments, processor 1300 may include branch prediction circuitry 1306.

Branch status table 1301 may be formed by a set of registers 1310, 1311, 1312, 1313, and 1314. Although five registers are shown, branch status table 1301 may include any number of registers. Branch status table 1301 may store a set of pointers with a set of branches. Each pointer 1320-1324 in the set of pointers may be associated with one or more branches 1330-1334 of the set of branches. Each branch 1330-1334 of the set of branches may be stored in a register 1310-1314. Each pointer 1320-1324 may be stored in a same register 1310-1314 as the corresponding branch 1330-1334. For example, pointer 1320 and branch 1330 may be associated together and may both be stored in register 1310.

In specific embodiments, each pointer 1320-1324 may be associated with a fetch group. In specific embodiments, at least one pointer may be associated with more than one branch, as a fetch group may contain more than one branch instruction. The fetch bundle may be a series of instructions appearing in program order and may include multiple not-taken branches and up to one taken branch. An entry in branch status table 1301 may not track any branch instruction, may track one branch instruction, or may track multiple branch instructions. depending on the fetch bundle of instructions that the entry refers to. For example, the entry of register 1312 does not track any branch; the entry of register 1311 tracks one branch, branch 1331; and the entry of register 1313 tracks two branches, branch 1332 and branch 1333. If the fetch bundle has multiple not-taken branches, it is possible that a mis-predicted branch will unwind some control instructions (e.g., vtype entries) but not others. To recover from the misprediction, control instruction buffer 1302 may track program counter offset values (relative to the beginning of the fetch bundle) for each control instruction. The mis-predicted branch may also have an offset within the fetch bundle. When recovering, the pointer in branch status table 1301 that points to control instruction buffer 1302 may be used to begin the search, and then the offsets may be used to identify the last control instruction before the mis-predicted branch inside the fetch bundle.

Control instruction buffer 1302 may store a set of instruction pipeline control data entries 1340, 1341, 1342, 1343, 1344, 1345, 1346, 1347, and 1348 in a set of addresses. Although nine instruction pipeline control data entries are shown, control instruction buffer 1302 may store any number of instruction pipeline control data entries. Each pointer 1320, 1321, 1322, 1323, and 1324 may identify an addresses, in the set of addresses, which stores the most recent instruction pipeline control data entry that proceeds the corresponding branch, entries 1341, 1342, 1345, 1347, and an empty entry respectively. The entry 1340, entry 1341, entry 1344, entry 1346, and entry 1348 then correspond to the first control instruction of the fetch groups of registers 1310, 1311, 1312, 1313, and 1314 respectively. In specific embodiments, the set of instruction pipeline control data entries 1340-1348 are associated with one or more vset instructions. In specific embodiments, control instruction buffer 1302 is a circular buffer. When a branch of instructions (e.g., branch 1331) is committed to instruction execution pipeline 1303, one or more instruction pipeline control data entries (e.g., entry 1341) that are associated with the branch, may be marked for deletion in control instruction buffer 1302.

In specific embodiments, processor 1300 includes instruction execution pipeline 1303 coupled to control instruction buffer 1302. The instruction execution pipeline 1303 may use a most recent entry (e.g., entry 1340) to control instruction buffer 1302 as a vtype register. In specific embodiments, instruction execution pipeline 1303 may be configured to access a most recent entry (e.g., entry 1340) to control instruction buffer 1302 when executing instructions. In specific embodiments, processor 1300 includes bundle of instructions 1304. Instruction execution pipeline 1303 may be configured to use control instruction 1350 (e.g., a configuration instruction) from bundle of instructions 1304, when executing bundle of instructions 1304, if any control instruction is in bundle of instructions 1304. Instruction execution pipeline 1303 may be configured to access a most recent entry (e.g., entry 1340) to control instruction buffer 1302, when executing bundle of instructions 1304, if there are no control instructions in bundle of instructions 1304.

In specific embodiments, processor 1300 includes instruction decoder 1305. Instruction decoder 1305 may be configured to store instruction pipeline control data entry 1340, of control instruction 1350, in control instruction buffer 1302 when control instruction 1350 is decoded. Instruction decoder 1305 may be configured to add a pointer from the set of pointers to branch status table 1301 when a branch is predicted and the control instruction 1350 is decoded. In specific embodiments, instruction decoder 1305 may be configured to detect a branch misprediction and reset head pointer 1325 of control instruction buffer 1302 to an address after the address associated with a newest control instruction that was not on the mis-predicted branch of the branch misprediction. That is, instruction decoder 1305 may be configured to reset head pointer 1325 of control instruction buffer 1302 to the address associated with the oldest control instruction that was on a mis-predicted branch of the branch misprediction (e.g., where an overwrite may start). For example, if branch 1330 had been mis-predicted, then head pointer 1325 may be changed to point to entry 1340, an address before mis-predicted branch 1330. Entry 1340 may be identified by the branch status table 1301 entry associated with branch 1330 and the program counter (PC) offset saved in entry 1340 and entry 1341. The PC offset of branch 1330 may be between the PC offset of entry 1340 and the PC offset of entry 1341. Entries 1340-1348 in control instruction buffer 1302 can be used to ensure that the appropriate control instruction is available for use by instruction execution pipeline 1303 at any given time regardless of branch mispredictions, while at the same time minimizing the size of branch status table 1301.

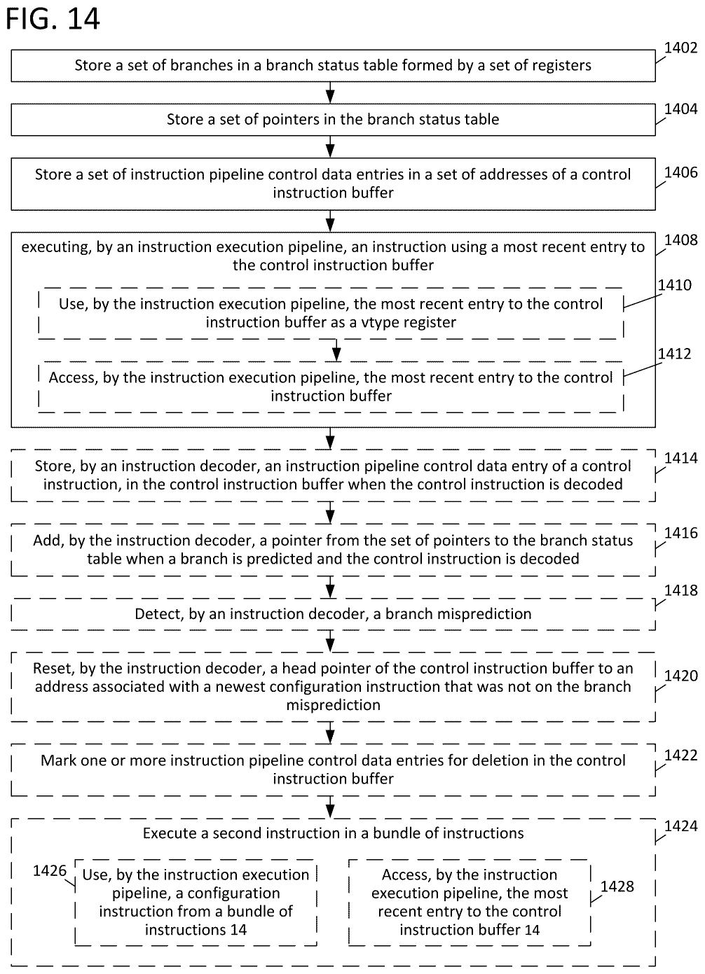

FIG. 14 illustrates an example of method 1400 for using a branch status table and a control instruction buffer with a processor instruction pipeline in accordance with specific embodiments of the inventions disclosed herein. Steps or portions of steps of method 1400 may be duplicated, rearranged, omitted, or otherwise deviate from the form shown. In specific embodiments, additional steps may be added to method 1400. In specific embodiments, portions of method 1400 may be performed in series or in parallel, or may overlap. For example, step 1404 may be performed before, after, or during step 1402. Step 1410 may be performed before, after, or during step 1412. Steps 1414-1422 may be performed before, after, or during step 1408.

At step 1402, a set of branches may be stored in a branch status table. The branch status table may be formed by a set of registers. In specific embodiments, the branch status table may be part of a RISC-V processor.

At step 1404, a set of pointers may be stored in the branch status table. In specific embodiments, at least one pointer in the set of pointers may be associated with more than one branch. In specific embodiments, at least one pointer in the set of pointers may not be associated with any branch instructions.

At step 1406, a set of instruction pipeline control data entries may be stored in a set of addresses of a control instruction buffer. The pointers (in the set of pointers stored at step 1404) may identify addresses, in the set of addresses, which store a set of most recent instruction pipeline control data entries, in the set of instruction pipeline control data entries. The set of most recent instruction pipeline control data entries may proceed the branches (in the set of branches stored at step 1402), that correspond with the pointers. In specific embodiments, the control instruction buffer may be part of a RISC-V processor and the set of instruction pipeline control data entries may be associated with one or more vset instructions.

At step 1408, an instruction may be executed using a most recent entry to the control instruction buffer. The instruction may be executed by an instruction execution pipeline.

In specific embodiments, and as part of executing the instruction, at step 1410 the instruction execution pipeline may use the most recent entry to the control instruction buffer as a vtype register.

In specific embodiments, and as part of executing the instruction, at step 1412 the instruction execution pipeline may access the most recent entry to the control instruction buffer.

In specific embodiments, at step 1414, an instruction decoder may store an instruction pipeline control data entry of a control instruction. The instruction pipeline control data entry may be stored in the control instruction buffer when the control instruction is decoded.

In specific embodiments, at step 1416, the instruction decoder may add a pointer from the set of pointers to the branch status table when a branch is predicted and the control instruction is decoded.

In specific embodiments, at step 1418, an instruction decoder may detect a branch misprediction.

In specific embodiments, at step 1420, the instruction decoder may reset a head pointer of the control instruction buffer to an address associated with a newest configuration instruction that was not on the mis-predicted branch.

In specific embodiments, at step 1422, one or more instruction pipeline control data entries may be marked for deletion in the control instruction buffer. The control instruction buffer may be a circular buffer. The one or more instruction pipeline control data entries may be from the set of instruction pipeline control data entries (e.g., stored at step 1406), and the one or more instruction pipeline control data entries may be associated with a branch of instructions that is committed to the instruction execution pipeline. In specific embodiments, the one or more instruction pipeline control data entries marked for deletion in the control instruction buffer may refer to a mis-predicted branch.

In specific embodiments, at step 1424, a second instruction in a bundle of instructions may be executed. The second instruction may be executed by the instruction execution pipeline. In specific embodiments, the bundle of instructions may include the instruction (e.g., executed at step 1408). In specific embodiments, the bundle of instructions may not include the instruction (e.g., executed at step 1408), such that a bundle of instructions including the instruction and the bundle of instructions including the second instruction may be different bundles of instructions.

In specific embodiments and as part of executing the second instruction, at step 1426, the instruction execution pipeline may use a configuration instruction from the bundle of instructions, if any configuration instruction is in the bundle of instructions.

In specific embodiments and as part of executing the second instruction, at step 1428, the instruction execution pipeline may access the most recent entry to the control instruction buffer, if there are no configuration instructions in the bundle of instructions.

Beneficially, when a branch misprediction occurs, the data structure can effectively be rewound to a point just before the misprediction with minimal overhead. The correct pointer will already be stored in the branch status table in the entry associated with the mis-predicted branch. Upon detecting a mis-prediction, the processing pipeline can be flushed, and the head pointer of the control instruction buffer can be set to the pointer value that corresponds to the last correctly predicted branch. The entries in the control instruction buffer can be used to ensure that the appropriate control instruction is available for use by the instruction pipeline at any given time regardless of branch mispredictions, while at the same time minimizing the size of the branch status table.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally directed to control instructions in RISC-V processors, the same approaches could be utilized to improve any parallel processing with configuration instructions. These and other modifications and variations to the present invention may be practiced by those skilled in the art, without departing from the scope of the present invention, which is more particularly set forth in the appended claims.

What is claimed is:

1. A processor comprising:
a branch status table formed by a set of registers and storing a set of pointers that correspond with a set of branches; and
a control instruction buffer storing a set of instruction pipeline control data entries in a set of addresses, wherein the pointers, in the set of pointers, identify addresses, in the set of addresses, which store a set of most recent instruction pipeline control data entries, in the set of instruction pipeline control data entries, which proceed the branches, in the set of branches, that correspond with the pointers.

2. The processor of claim 1, wherein:
the processor is a RISC-V processor; and
the set of instruction pipeline control data entries are associated with one or more vset instructions.

3. The processor of claim 1, further comprising:
an instruction execution pipeline coupled to the control instruction buffer;
wherein the instruction execution pipeline uses a most recent entry to the control instruction buffer as a vtype register.

4. The processor of claim 1, further comprising:
an instruction execution pipeline coupled to the control instruction buffer;
wherein the instruction execution pipeline is configured to access a most recent entry to the control instruction buffer when executing instructions.

5. The processor of claim 1, further comprising:
a bundle of instructions; and
an instruction execution pipeline coupled to the control instruction buffer;
wherein the instruction execution pipeline is configured to: (i) use a configuration instruction from the bundle of instructions, when executing the bundle of instructions, if any configuration instruction is in the bundle of instructions; and (ii) access a most recent entry to the control instruction buffer, when executing the bundle of instructions, if there are no configuration instructions in the bundle of instructions.

6. The processor of claim 1, further comprising:
an instruction decoder;
wherein the instruction decoder is configured to: (i) store an instruction pipeline control data entry, of a control instruction, in the control instruction buffer when the control instruction is decoded; and (ii) add a pointer from the set of pointers to the branch status table when a branch is predicted and the control instruction is decoded.

7. The processor of claim 1, further comprising:
an instruction decoder;
wherein the instruction decoder is configured to:
detect a branch misprediction; and
reset a head pointer of the control instruction buffer to an address associated with a newest configuration instruction that was not on the branch misprediction.

8. The processor of claim 1, further comprising:
an instruction pipeline;
wherein: (i) the control instruction buffer is a circular buffer; and (ii) when a branch of instructions is committed to the instruction pipeline, one or more instruction pipeline control data entries, from the set of instruction pipeline control data entries, that are associated with the branch, are marked for deletion in the control instruction buffer.

9. The processor of claim 1, wherein:
at least one pointer in the set of pointers is associated with more than one branch.

10. A method comprising:
storing entries for a set of branches in a branch status table formed by a set of registers;
storing a set of pointers in the branch status table, wherein the set of pointers correspond with the set of branches;
storing a set of instruction pipeline control data entries in a set of addresses of a control instruction buffer, wherein the pointers, in the set of pointers, identify addresses, in the set of addresses, which store a set of most recent instruction pipeline control data entries, in the set of instruction pipeline control data entries, which proceed the branches, in the set of branches, that correspond with the pointers; and
executing, by an instruction execution pipeline, an instruction using a most recent entry to the control instruction buffer.

11. The method of claim 10, wherein:
the branch status table and the control instruction buffer are part of a RISC-V processor; and
the set of instruction pipeline control data entries are associated with one or more vset instructions.

12. The method of claim 10, wherein executing the instruction comprises:
using, by the instruction execution pipeline, the most recent entry to the control instruction buffer as a vtype register.

13. The method of claim 10, wherein executing the instruction comprises:
accessing, by the instruction execution pipeline, the most recent entry to the control instruction buffer.

14. The method of claim 10, further comprises:
executing a second instruction in a bundle of instructions;
using, by the instruction execution pipeline and as part of executing the second instruction, a configuration instruction from the bundle of instructions, if any configuration instruction is in the bundle of instructions; and
accessing, by the instruction execution pipeline and as part of executing the second instruction, the most recent entry to the control instruction buffer, if there are no configuration instructions in the bundle of instructions.

15. The method of claim 10, further comprising:
storing, by an instruction decoder, an instruction pipeline control data entry of a control instruction in the control instruction buffer when the control instruction is decoded; and
adding, by the instruction decoder, a pointer from the set of pointers to the branch status table when a branch is predicted and the control instruction is decoded.

16. The method of claim 10, further comprising:
detecting, by an instruction decoder, a branch misprediction; and
resetting, by the instruction decoder, a head pointer of the control instruction buffer to an address associated with a newest configuration instruction that was not on a mis-predicted branch of the branch misprediction.

17. The method of claim 10, further comprising:
marking one or more instruction pipeline control data entries for deletion in the control instruction buffer, the control instruction buffer being a circular buffer, wherein the one or more instruction pipeline control data entries are from the set of instruction pipeline control data entries, and the one or more instruction pipeline control data entries are associated with a branch of instructions that is committed to the instruction execution pipeline.

18. The method of claim 10, wherein:
at least one pointer in the set of pointers is associated with more than one branch.

19. A processor comprising:
a branch status table formed by a set of registers, a register of the set of registers storing a pointer and information about a set of instructions; and
a control instruction buffer storing a set of instruction pipeline control data entries in a set of addresses, wherein the pointer identifies an addresses, in the set of addresses, which stores a set of most recent instruction pipeline control data entries, in the set of instruction pipeline control data entries, which proceeds the set of instructions.

20. The processor of claim 19, wherein:
the processor is a RISC-V processor; and
the set of instructions includes one or more vset instructions.
